(19) United States
(12) Patent Application Publication
(10) Pub. No.: US 2025/0061587 A1
(43) Pub. Date: Feb. 20, 2025

(54) MANAGING OBJECT TRACKING

(71) Applicant: Topgolf Sweden AB, Danderyd (SE)

(72) Inventors: Stein Norheim, Spånga (SE); Joakim Hugmark, Täby (SE)

(21) Appl. No.: 18/807,098

(22) Filed: Aug. 16, 2024

(30) Foreign Application Priority Data
Aug. 17, 2023 (SE) 2330356-3

(51) Int. Cl. G06T 7/20; G06V 10/25

(52) U.S. Cl. CPC G06T 7/20; G06V 10/25

(57) ABSTRACT

A method and a computing apparatus for managing tracking of an object moving in a three-dimensional environment are disclosed. The computing apparatus determines that an observation relating to the object matches a region. In an evaluation action, evaluating whether the observation and/or the path fulfills a region tracking condition of the region or not. The computing apparatus retains, based on the evaluation action, the observation and/or the path in continued tracking of the object. Alternatively, the computing apparatus discards, based on the evaluation action, the observation and/or the path from continued tracking of the object. Corresponding computer program(s) and computer program carrier(s) are also disclosed.

### CROSS-REFERENCE TO RELATED APPLICATIONS

This application claims the benefit of priority under 35 U.S.C. § 119 (a) of Swedish Patent Application No. 2330356-3, entitled “MANAGING OBJECT TRACKING”, filed Aug. 17, 2023.

### BACKGROUND

### Technical Field

The embodiments herein relate to tracking of objects, such as sports projectiles, golf balls, tennis balls, or the like, which are moving in an environment, such as indoors, outdoors, on a soccer field, in a golfing area or the like. In particular, a computer-implemented method and a computing apparatus for managing tracking of an object are disclosed. A corresponding computer program and a carrier therefor are also disclosed.

### Description of Related Art

In order to track objects, it is common to use a sensor, such as a camera, a radar or the like, to capture a sequence of images of a moving object. When the sensor is used to track one or more moving objects, a tracking program in a computer is usually used. The tracking program can distinguish signals, originating from tracked objects, from other signals, such as static objects and noise, in the image captured by the sensor. This is typically done by either using a fixed noise threshold for the signal, or by using an adaptive method that uses statistics to set a dynamic noise threshold level, based on the image data from the sensor itself.

One difficulty with this approach is that there can be other objects or external environmental conditions that cause other, stronger, signals to be present in the image data from the sensor. For example, if the sensor is a camera, and the environment is a grass field in a suburban area, traffic, cars and headlights might result in very strong signals in the image data from the camera. Disadvantageously, this can make it difficult to track objects in the image. Furthermore, if it is raining or snowing, such weather conditions can cause hundreds or thousands of relatively strong signals in the image data at the same time.

A problem may thus be how to improve tracking during varying conditions and environments with unexpected signals.

### SUMMARY

An object is to alleviate, or eliminate, one or more of the problems and/or disadvantages mentioned herein.

According to an aspect, the object is achieved by a method, e.g. performed by a computing apparatus, for managing tracking of an object moving in a three-dimensional environment. The computing apparatus obtains an indication of a region and a region tracking condition to be applied to the tracking of the object in the region. The region pertains to a portion of a field of view of an electromagnetic sensor for tracking of the object in the three-dimensional environment. The computing apparatus obtains an observation relating to the tracking of the object. The observation is generated based on at least one two-dimensional representation of the field of view (125), wherein said at least one two-dimensional representation has been captured by the electromagnetic sensor, and wherein the observation is includable in a set of observations defining a path of the object in the field of view. The computing apparatus determines that the observation matches the region. In an evaluation action, the computing apparatus evaluates whether the observation and/or the path fulfills the region tracking condition of the region or not. Furthermore, the computing apparatus retains, based on the evaluation action, the observation and/or the path in continued tracking of the object. The computing apparatus discards, based on the evaluation action, the observation and/or the path from continued tracking of the object. The region tracking condition comprises one or more of:
a) a first instruction that the path shall be discarded when the path includes one observation,
b) a second instruction that the path shall be discarded when the path, including the observation, fulfils a criterion relating to one or more of an angle, a speed, and a jaggedness,
c) a third instruction that the observation shall be discarded, and that the observation shall be replaced with an extrapolated observation derived from the path, in which the observation is not included,
d) a fourth instruction that the observation shall be included in order to continue the tracking of the object, while not allowing use of an extrapolated observation derived from the path, in which the observation is not included, and
e) a fifth instruction that the observation, comprising a blob, shall be discarded when a brightness of the blob is less than a brightness of a background at the blob.

The region tracking condition can thus comprise the first instruction, the second instruction, the third instruction, the fourth instruction, the fifth instruction, or any combination of two or more thereof. Expressed differently, this means that the region tracking condition may comprise any one of the first to fifth instructions or a combination of two or more instructions selected from the first to fifth instructions.

Thanks to the region(s) and the associated region tracking condition(s), the number of probable observations and/or paths that need to be evaluated in continued tracking is reduced. Advantageously, consumption of computing and/or memory resources required for the tracking of the object, or objects, is reduced. In turn, this means that the tracking becomes more efficient, e.g. in terms of cost, time, and/or energy consumption, or the like.

With some embodiments herein, domain-specific knowledge, both about the geometry of the object and/or environment observed, leverages accuracy and/or efficiency of the tracking of the object.

According to another aspect, the object is achieved by a computing apparatus configured for managing tracking of an object moving in a three-dimensional environment. The computing apparatus is configured for obtaining an indication of a region and a region tracking condition to be applied to the tracking of the object in the region. The region pertains to a portion of a field of view of an electromagnetic sensor for tracking of the object in the three-dimensional environment.

The computing apparatus is configured for obtaining an observation relating to the tracking of the object. The observation is generated based on at least one two-dimensional representation of the field of view (125), wherein said at least one two-dimensional representation has been captured by the electromagnetic sensor, and wherein the observation is includable in a set of observations defining a path of the object in the field of view. The computing apparatus is configured for determining that the observation matches the region. In an evaluation action, the computing apparatus is configured for evaluating whether the observation and/or the path fulfills the region tracking condition of the region or not. The computing apparatus is configured for retaining, based on the evaluation action, the observation and/or the path in continued tracking of the object. The computing apparatus is configured for discarding, based on the evaluation action, the observation and/or the path from continued tracking of the object. The region tracking condition comprises one or more of:
a) a first instruction that the path shall be discarded when the path includes one observation,
b) a second instruction that the path shall be discarded when the path, including the observation, fulfils a criterion relating to one or more of an angle, a speed, and a jaggedness,
c) a third instruction that the observation shall be discarded, and that the observation shall be replaced with an extrapolated observation derived from the path, in which the observation is not included,
d) a fourth instruction that the observation shall be included in order to continue the tracking of the object, while not allowing use of an extrapolated observation derived from the path, in which the observation is not included, and
e) a fifth instruction that the observation, comprising a blob, shall be discarded when a brightness of the blob is less than a brightness of a background at the blob.

As before, the region tracking condition can comprise the first instruction, the second instruction, the third instruction, the fourth instruction, the fifth instruction, or any combination of two or more thereof.

According to further aspects, the object is achieved by computer programs and computer program carriers corresponding to the aspects above.

### BRIEF DESCRIPTION OF THE DRAWINGS

The various aspects of embodiments disclosed herein, including particular features and advantages thereof, will be readily understood from the following detailed description and the accompanying drawings, which are briefly described in the following.

FIG. 1 is a schematic overview of an example of a system in which embodiments herein may be implemented.

FIG. 2 is an exemplifying illustration showing regions of an environment captured by an electromagnetic sensor.

FIG. 3 is a flowchart illustrating embodiments of the method herein, e.g. performed by the computing apparatus.

FIG. 4 is another flowchart illustrating embodiments of the method herein, e.g. performed by the computing apparatus.

FIG. 5 is a block diagram illustrating embodiments of the computing apparatus.

### DETAILED DESCRIPTION

As an example of methods for tracking moving objects using one or more cameras depicting a space where the moving objects exist, it may be that the tracking is performed by first identifying an object as one image pixel, or a set of adjacent pixels, that deviate from a local background. This is often referred to as blob detection. Once a number of blobs have been detected in several image frames, possible tracked object paths are identified by interconnecting identified blobs in subsequent frames. This is often referred to as a tracking procedure.

The blob generation in each individual frame potentially results in very many false positive blobs, in other words identified blobs that do not really correspond to an existing moving object. This may be due to noise, shifting lighting conditions and non-tracked objects occurring in the field of view of the camera in question.

The detection of possible tracked object paths normally results in a reduction of such false positives, for instance based on filtering away of physically or statistically implausible paths. Due to the large number of false positive blob detections, however, even if most of the false positives are filtered away in the tracked paths detection step, the blob detection itself is associated with heavy memory and processor load and may therefore constitute a bottleneck for the object tracking even if high-performance hardware is used.

Moreover, as the performance of digital cameras increases, pixel data output from such cameras increases correspondingly. In order to achieve accurate tracking of moving objects, it is desired to use as accurate and precise image information as possible.

Blob detection and/or tracking procedure are known from e.g. US 20220051420A1, US-2022-0138969-A1 and other documents.

Since it is normally desired to avoid too many non-detected blobs (false negatives), leading to potentially missed tracked object paths, a relatively large share of false positive blob detections can be accepted.

In order to better appreciate, the present disclosure the following insights by the inventors are presented.

Continuing from the sensor mentioned in the background section, such sensor, e.g. a radar, a camera, a lidar etc., has a field-of-view (FoV), i.e. a portion of the environment observed, aka captured, by the sensor. The present inventors have observed that in many cases, the noise level will not be constant throughout the FoV, but instead it will vary depending on where in the FoV the noise level is measured. Furthermore, the Signal-to-Noise Ratio (SNR) for the moving object to be tracked may also vary, depending on the position of the object in the sensor's FoV.

Specifically in the case of a camera, different parts of the image from the camera may have different levels of noise, different expected SNRs and different characteristics of the noise. If the objective is to track a moving object or projectile, it is also expected that the signal has different characteristics, such as SNR or the like, in different parts of the image, depending on how the camera is located and aimed compared to the distance to the object to be tracked, and to the direction of movement of the tracked object.

When tracking objects, a difficulty is how to find the first observation of the object, or the first two or three observations. This may sometimes be referred to as a launch, or start, of the path. A reason for the difficulty in finding the first observation is that any signal detected above the noise threshold can be a first observation, such as a so called blob or the like. The second observation is also difficult to evaluate, since in that case there is only one observation to base a prediction upon. When no assumptions can be made about the direction, in case only the first observation has been obtained, all subsequent observations sufficiently close to the first observation need to be considered to be candidates for becoming the second observation. As a result, a lot of computing resources are required to identify possible launches, or starts, of new objects' paths.

Furthermore, with many possible starts, or launch occasions, more memory is required, since the possible paths need to be tracked and evaluated for all identified start occasions.

As used herein, the term “observation” may be a blob. The observation may refer to a location of interest in an image frame. The location may be of interest, e.g. due to that the location, or set of pixels, are outside a noise level, e.g. compared to a preceding image frame. The set of pixels, i.e. one or more pixels, are a continuous collection of pixels in that each pixel of the set is directly adjacent to at least one other pixel in the set. An observation, or set of data points, can be an actual observation, e.g. obtained by blob detection, or an extrapolated observation, e.g. obtained based on existing blobs of a particular path. The term “blob” may thus refer to any set of directly adjacent pixels that have been identified as changed from one image frame to another image frame and that are not considered to be noise, e.g. are outside, or above, a noise threshold. As mentioned, it is sufficient that each pixel of the set is directly adjacent to at least one other pixel of the set.

The expression “launch”, or “start”, have been used interchangeably and refers to a path with only one, or few, observations.

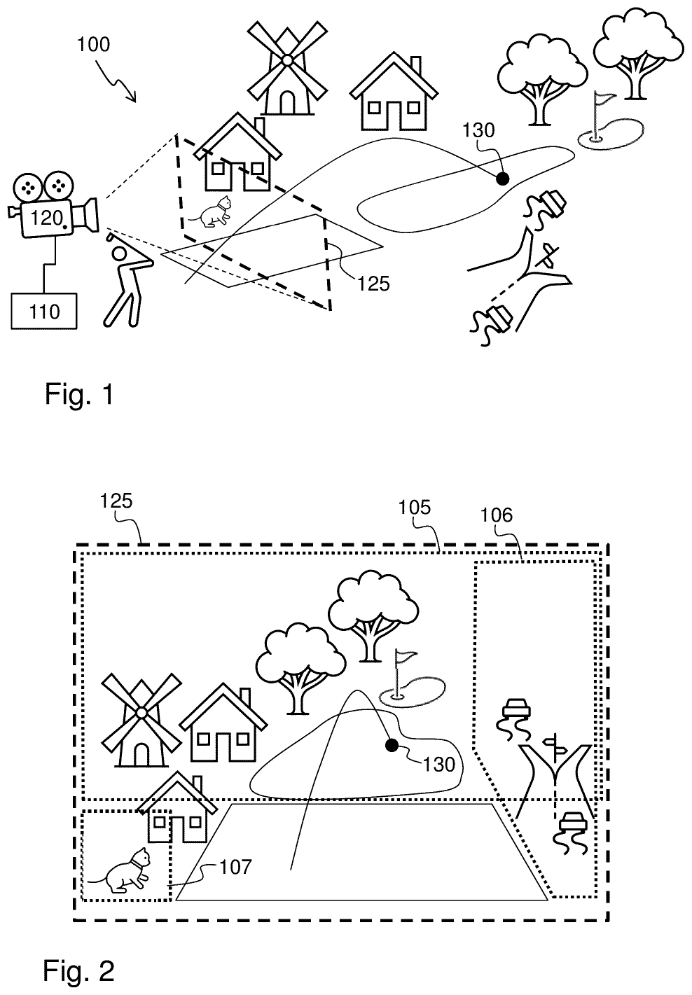

FIG. 1 illustrates a three-dimensional environment 100, including a portion of a sports area. The sports area is surrounded by surrounding areas, such as housing areas, traffic areas, bush areas, or the like. The sports area can be a golfing area, a golf course, a driving range, a soccer field, a tennis court, a football field, a table tennis court, or the like.

In a typical setup for tracking of a golf ball 130 that is shot from a location in the golfing area, an electromagnetic sensor 120 for tracking of the golf ball is provided. This means for example that the electromagnetic sensor 120 is arranged, such as mounted, installed, or the like, to capture a portion of the golfing area, e.g. in a so called field of view of the electromagnetic sensor 120. The electromagnetic sensor 120 can include an imaging device configured for capturing a sequence of images forming a video, a video recorder, a digital video recorder, a camera, a digital camera, an imaging device, an image sensor, a radar sensor, a radar device, a combination thereof or the like. More explicitly, this means that the electromagnetic sensor 120 may be, or be embodied as, any one of the aforementioned examples that represent electromagnetic sensors having a field of view.

The portion of the sports area, e.g. the golfing area, is thus located in a field of view (FoV) 125 of the electromagnetic sensor 120. The field of view is represented by, or projected onto or the like, an array or matrix of pixels of the electromagnetic sensor 120. The pixels may be sensitive to electromagnetic radiation of various types, such as light, visible light, X-ray, radar, ultraviolet light and more. When the electromagnetic sensor 120 captures an image, the image will be a two-dimensional (2D) representation of the portion of the golfing area that is located within the electromagnetic sensor's field of view 125.

The term “field of view of the electromagnetic sensor” may refer to a field of view of an image sensor of the camera, a field of view of a radar sensor or the like. Sometimes, the terms “FoV” and “image” may be used interchangeably.

A path may be defined by a set of observations, such as blobs. The blobs may be detected in images captured by the electromagnetic sensor 120. Each blob, or observation, may have a position, a size, and brightness level. The position, e.g. in at least two-dimensions, is, at least initially, in the coordinate system of the electromagnetic sensor. The size may refer to e.g. width and height of the blob. The brightness level may be an average of the pixels of the blob or any other aggregated measure of the brightness of the pixels in the blob.

As used herein, a path refers to a sequence of two-dimensional coordinates of observations, a sequence of observations, or a sequence of blobs, that may represent the movement of an object along a trajectory, projected in the image plane. Most paths that are constructed in the early stages of tracking are false positives that can be eliminated in later stages, or never become sufficiently long to be assumed as belonging to an actual sports projectile.

As used herein, the term “image” refers to a two-dimensional representation of a field of view of an electromagnetic sensor. An image can thus comprise information captured by e.g. cameras, radars, image sensors, or the like. In some examples, the image is represented by a matrix of pixels of a 2D image sensor.

Once the setup has been completed, it may be that tracking of the golf ball is less accurate in some regions of the field of view 125. For this reason, a person may define at least one region 105, 106, 107 that pertains to a portion of the field of view 125 of the electromagnetic sensor 120. See the exemplifying regions 105, 106, 107 in FIG. 2. The person may be an operator, a user, a human, a golf player, a golfing area employee, or the like.

By allowing the person to define the shapes of the region(s) directly in a visualization of the sensor input, it's much easier for the person to reason around which conditions to apply, and the exact extent of the region(s) marked, such as defined, or the like.

In addition, the person may define, e.g. in case there is only one region, a region tracking condition for application to the tracking of the object 130 in the region. In more detail, the region tracking condition may be applied to the observation(s) in the region, or in some examples to path(s) entering the region. As an example, in case of multiple regions, the person may define a respective region tracking condition for each region of said multiple regions. One or more of the respective region tracking conditions may be the same, or similar. Likewise, one or more of the respective region tracking conditions may be different from each other. Moreover, one or more regions may overlap, or may not overlap, with each other.

This means for example, in a case with three regions, that there can be a first region, a second region and a third region. Purely as an example, the first region can be at least partly overlapping with the second region and the third region may not be overlapping with any one of the first and second regions. Still purely as an example, the first region can be associated with a first region tracking condition, the second region can be associated with a second region tracking condition, and the third region can be associated with a third region tracking condition. Continuing of the purely exemplifying description, the first region tracking condition can be the same as, or similar to, the third region tracking condition, while e.g. the second region tracking condition can be different from the first and third region tracking conditions. As already mentioned, each region can be associated with one or more region tracking conditions. Thus, as a further purely illustrative example, it can be that the three regions can be associated with a common region tracking condition that is applicable to all of the first, second and third regions and that the three regions are further associated with a respective region tracking condition, where each respective region tracking condition is unique for the corresponding region. In this example, it means that each region is associated with two region tracking conditions, where one region tracking conditions is the common region tracking condition that is the same for all the three regions.

In view of the above, there is provided exemplifying methods for managing tracking of the object 130 moving in the three-dimensional environment 100, where different, or same, region tracking conditions are applied to the tracking, e.g. including starts, continued movement or the like. Furthermore, in some embodiments, the observation(s) can be processed, such as filtered, compared to region tracking condition(s), or the like, based on e.g. direction and/or position in the FoV of the observation.

As a general overview, it may be noted that the exemplifying methods herein can include the following main actions.

1. The operator identifies a region in the FoV of the electromagnetic sensor where the external environment measured by the electromagnetic sensor exhibits characteristics that may cause a tracking algorithm to have a high failure rate within that region. The region can be marked geometrically by the operator, for example in the shape of a polygon, such as a rectangle, triangle, irregular polygon, or the like. The operator can place corners of a region, either by specifying their coordinates in the image (or other relevant coordinate system for the sensor), or by clicking in a user-interface representing the image in order to create the regions. If the user-interface representing the image can show noise levels in the image, as well as the objects being tracked, it's possible for the operator to identify regions in the image where noise levels are high, or regions where object tracking is difficult, and then mark these regions.

2. A region tracking condition is defined for the identified region. The region tracking condition can be an instruction to apply a different noise threshold level, restrictions on the direction of a velocity vector that a tracked object can have, or that tracking should be suspended completely within the area, or some other condition as described in more detail herein. The region tracking conditions may predefined, or the operator may possibly adjust/generate/create conditions dynamically, e.g. on the go.

3. With the method herein, an observation, or typically a set of observations, is evaluated toward the region(s) as defined in 1 and the corresponding region tracking condition(s) as defined in 2. When an observation is considered for being added to a path, the new path with the candidate observation is tested against these criteria. Then, the observation is either kept or prevented from being added to the path, based on the result. When the observation is kept, it can be included in the path for which tracking is continued. When the observation is discarded, either only the present observation will be discarded from the path, or the present path will be discarded and thus not included in continued tracking. An observation that has been rejected from one path might still be accepted into one or more other paths.

Some embodiments provide a flexible and versatile solution for application of region tracking conditions, e.g. in terms of shapes of the region in which the region tracking condition shall be applied, in terms what region tracking condition that may be applied. The shape of the region(s) can include polygonal shape, rectangular shape, triangular shape, circular shape, irregular shapes formed by a number of curves, free form shape(s), or the like. Notably, at least some of the region tracking conditions herein make use of the person's knowledge about the object's expected motion behavior, e.g. in a specific region.

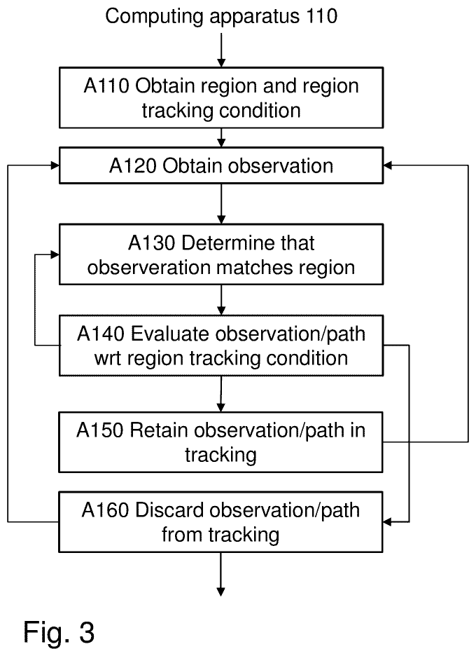

FIG. 3 shows an exemplifying method for managing tracking of the object 130 moving in the three-dimensional environment 100. As an example, the computing apparatus 110 performs the method for managing tracking of the object 130 moving in the three-dimensional environment 100.

One or more of the following actions can be performed, e.g. in the order as below or in any other suitable order when applicable. Also, when computationally suitable, these operations can be performed in batch for multiple observations in one step.

### Action A110

The computing apparatus 110 obtains, such as receives, reads, fetches or the like, an indication of a region 105, 106, 107 and a region tracking condition, which is to be applied to the tracking of the object 130 in the region 105, 106, 107. The region 105, 106, 107 pertains to a portion of the field of view 125 of the electromagnetic sensor 120 for tracking of the object 130 in the three-dimensional environment 100. The indication of a region may be referred to as a region indication. In some examples, the computing apparatus 110 can obtain a list of region indications and corresponding region tracking conditions. The region indication(s) and the region tracking condition(s) may be predetermined or dynamically determined, e.g. by the person.

In some examples, the indication of the region 105, 106, 107 and the region tracking condition may be obtained by that the person inputs the indication of the region 105, 106, 107 and the region tracking condition, e.g. directly into the computing apparatus 110 or via another device, such as a PC, smartphone or the like.

In some examples, the computing apparatus 110 can receive, such as read, fetch or the like, the indication of the region 105, 106, 107 and the region tracking condition from a memory, such as an external or internal memory. An external memory can be external to the computing apparatus 110, such as a portable drive, a remote memory, a cloud storage or the like. An internal memory can be internal, e.g. within a casing of the computing apparatus 110, such as a hard drive, a disc drive, a persistent computer memory or the like.

In some embodiments, the obtaining A110 comprises obtaining a further indication of a further region 105, 106, 107 and a further region tracking condition to be applied to the tracking of the object 130 in the further region 105, 106, 107, wherein the further region 105, 106, 107 pertains to a portion of the field of view 125.

In some embodiments, the region 105, 106, 107 partially overlaps with the further region 105, 106, 107 and both of the region 105, 106, 107 and the further region 105, 106, 107 cover less than all of the field of view 125.

In some examples, the regions 105, 106, 107 may be determined by the user. Accordingly as above, the region(s) and/or the further region(s) 105, 106, 107 can be received as user input, e.g. input by the person, e.g. using a keyboard, a mouse or the like.

Similarly, in some examples, the region tracking condition may be determined by the user. Accordingly as above, the region tracking condition(s) and/or the further region tracking condition(s) can be received as user input, e.g. input by the person, e.g. using a keyboard, a mouse or the like.

### Action A120

The computing apparatus 110 obtains an observation relating to the tracking of the object 130. The observation is generated based on at least one two-dimensional representation of the field of view (125), wherein said at least one two-dimensional representation has been captured by the electromagnetic sensor 120, such as at least one image. Said at least one image can e.g. include two or more images. The observation is includable in a set of observations defining a path of the object 130 in the field of view 125. The aforementioned documents relating to known tracking procedures provides some examples on associating an observation with a path, e.g. a new path or a continuation of an existing path. The observation can be a blob, a pattern, or the like. In practice, the computing apparatus 110 can obtain hundreds or thousands of observations from each image. Most of the observations are false positives, i.e. observations that do not actually originate from one or more moving sports projectiles. Of course, some of the observations can be true positives, i.e. observations that in fact originate from one or more moving sports projectiles. False positive observations can be noise, branches of a tree that move in the wind, etc.

The computing apparatus 110 can obtain the observation by applying any commonly known blob detection procedure, such as a blob detection procedure based on differential, spatio-temporal, and grey-level characteristics in the captured images, on filtering, on masking or the like.

### Action A130

The computing apparatus 110 determines that the observation matches the region 105, 106, 107. This action can refer to that the computing apparatus 110 can check whether the observation, e.g. a position of the observation in the FoV matches the region, e.g. is in the region. The position of the observation can be given as an explicit point, having a pair of coordinates, in the image. The explicit point can be a center point of the observation, an upper left point of the observation, a lower left point of the observation, a lower right point of the observation, an upper right point of the observation or the like. The point can then be either inside or outside of the region. If the point is on a border of the region, it can be consistently determined to be either inside or outside of the region. In this manner, the matching avoids unclear outcomes in case, an area of the blob reaches into, or partly covers, multiple regions. In case the observation does not match the region, the computing apparatus 110 can proceed with any existing further region tracking condition as will be described in more detail below.

### Action A140

In an evaluation action A140, the computing apparatus 110 evaluates whether the observation and/or the path fulfills the region tracking condition of the region 105, 106, 107 or not. The region tracking condition can apply to the observation, the path or both.

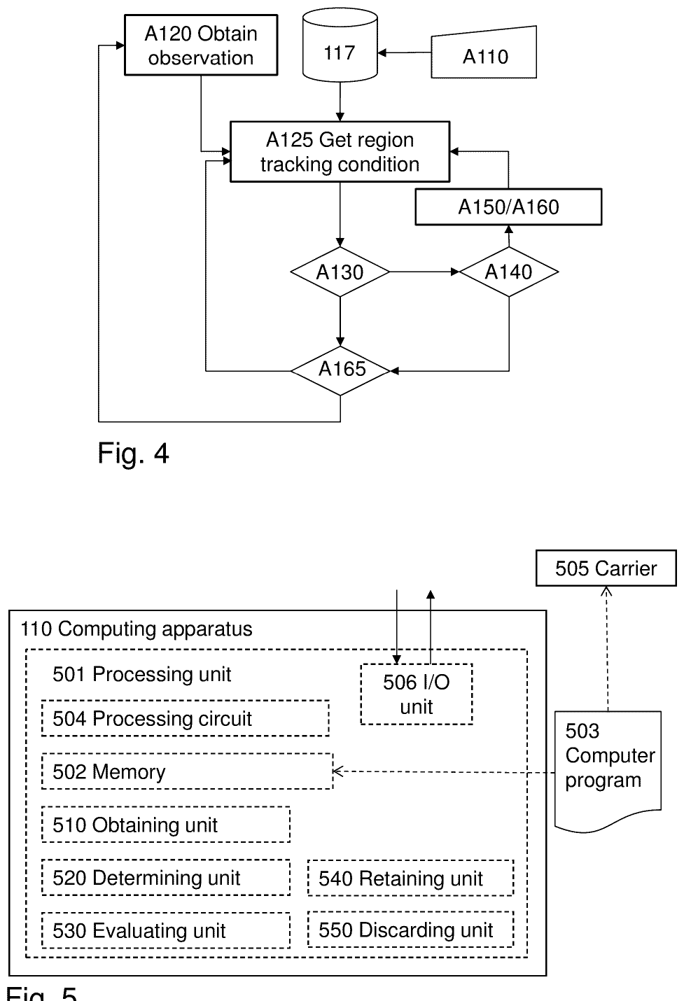

This action may refer to that the computing apparatus 110 can determine that the observation and/or the path fulfills the region tracking condition. Alternatively, as described in connection with FIG. 4, the method may return to action A130 in order to evaluate any existing further region(s) and any existing further region tracking condition(s).

### Action A150

The computing apparatus 110 retains, based on the evaluation action A140, the observation and/or the path in continued tracking of the object 130.

The expression “based on the evaluation action A140” may e.g. mean that the computing apparatus 110 retains the observation and/or the path in continued tracking when the observation and/or path fulfills the region tracking condition, or as the case may be when the observation and/or path fails to satisfy the region tracking condition. In some examples, it may be described as that the evaluation concerns whether or not the observation is allowed to be added to a path, e.g. with respect to the currently evaluated region tracking condition.

### Action A160

The computing apparatus 110 discards, based on the evaluation action A140, the observation and/or the path from continued tracking of the object 130.

The expression “based on the evaluation action A140” may e.g. mean that the computing apparatus 110 discards the observation and/or the path from continued tracking when the observation and/or path fails to satisfy the region tracking condition, or as the case may be when the observation and/or path fulfills the region tracking condition.

Typically, only one of action A150 and A160 is performed, e.g. for each region in case of evaluation of multiple regions and for each observation, e.g. when multiple observations are obtained in action A120.

Thanks to action A150 and A160, it is ensured that the observations maintained in the path for the object 130 fulfills the region tracking condition(s).

In the following, the actions above are further elaborated upon with reference to a plurality of exemplifying instructions which can be included in the region tracking condition(s). This means that the region tracking condition includes one or more of said instructions, such as any one of said instructions or a combination of two or more of said instructions.

a)

The region tracking condition can comprise a first instruction that the path shall be discarded when the path includes one observation, e.g. where the observation is positioned in the region of the FoV where the region tracking conditions is to be applied. In some examples, the path can be discarded when the path includes only one observation.

In this manner, the number of starts, or launches, in the observed region may be restricted, such as reduced, decreased, or the like.

To reduce the number of launches that the computing apparatus 110 may need to keep track of, the computing apparatus 110 may take advantage of, or use, knowledge from the fact that sports projectiles, such as golf balls, or the like, are tracked and from the fact that the sports projectiles usually don't launch in all parts of the FoV of the sensor. Regions, or parts, of the FoV, in which the sports projectiles never start, or launch, can be identified, e.g. manually or using a supervised or unsupervised neural network. However, the sports projectile may pass by such identified regions. This means that these regions may not be excluded altogether, but only for the start of the tracking. Accordingly, this region tracking condition allows continued tracking of an already tracked path, but disallows a new path from starting within the specified region, i.e. no launch is allowed.

b)

The region tracking condition can comprise a second instruction that the path shall be discarded when the path, including the observation, fulfils a criterion relating to one of more of angle, direction, speed, spin, jaggedness or a combination thereof. The angle/direction/speed/spin/jaggedness may be derived from the path.

### Angle, or Direction

In this example, the criterion relates to the angle, or direction of the path. This may be performed in order to filter out, or filter in, paths moving in a range of specific angles, or directions. In some cases, there may be noise that follows a specific geometric/spatial pattern, which will give rise to path with a specific movement direction in a region of the sensor's FoV. One example is a vertical truss or pole moving in the wind, which can give rise to vertical paths in a region of the FoV. Another example can be a road with traffic that moves in a very specific direction.

For this region tracking condition, paths are filtered by first computing the angle v, between a directional vector of the path a, and the directional vector of the direction that shall be filtered in or out b, by calculating the dot product between these two vectors:

a·b=|a∥b| cos v

If this angle, v, is less than an angle threshold, T, the path is discarded or kept, depending on if the direction shall be filtered in or filtered out.

In this context, it may be noted that the directional vector of the path may be given by a difference vector between the last added observation and its predecessor. However, sometimes a more sophisticated approach may be applied using a predictive method, e.g. by use of a Kalman filter, polynomial approximations or the like.

According to two further examples of this region tracking condition, there is a unidirectional example, where the sign of the angle is considered—if the sign of the angle is negative, the path is kept—and the bidirectional example, where only the absolute value of the angle is considered: The bidirectional example may be useful to filter out a branch with leaves that oscillates, such as swings back and forth, or the like, in the wind.

### Unidirectional:

If a·b<|a∥b| cos (T) (expression 1) then discard path.

### Bidirectional:

If |a·b|<|a∥b| cos (T) (expression 2) then discard path.
For reasons of computational efficiency, expression 2 above may be calculated as |a·b|²<|a|²|b|² cos² (T) to avoid square root calculations, under the constraint that T<90 degrees. Similarly, expression 1 may be rewritten to avoid square root calculations.

As above, the unidirectional and bidirectional example may be applied for filtering in or filtering out certain angles/directions.

### Jaggedness

In this example, the criterion relates to jaggedness of the path. This means that the criterion puts a limit on the jaggedness of the path. If the tracked object can be assumed to be in free flight, with only external forces, e.g. due to gravity, wind, friction etc., acting on it, the path of the object can be assumed to be smooth, i.e. no sudden directional changes from one observation to another shall be expected. In the case of sports projectile tracking, such as tracking of a golf ball, this can be assumed to be the case when the ball travels in the air without contact with the ground, e.g. when a background around the sports projectile resembles the sky. The sky can be assumed to be white, blue or have a typical appearance. Noise and objects which are not only affected by external forces (such as birds and insects) are not limited in the same way in their movement pattern. Similarly, a golf ball bouncing or rolling on the ground is not in free flight and therefore might move in a more stochastic manner. Further, the background of such sports projectile would usually not resemble the sky. It is therefore beneficial to impose a limit on the jaggedness of the path, but only in certain parts of the FoV of the sensor.

This may also mean that the object, such as a golf ball, or the like, flies in a relatively straight pattern, and not in a zig-zag form as an insect, such as a fly, or the like, can do. But the object is not expected to fly completely straight since it is always affected by gravity, while e.g. a bird can overcome gravity when flying around. The region tracking condition related to jaggedness can help in filtering in/out the kind of characteristics of the motion of the tracked object.

The jaggedness can be estimated in many ways, such as by counting the number of directional changes higher than a certain number of degrees between adjacent observations, over the time of the path, or as a frequency. Another example would be to calculate the shortest path between two observations, such as points, in the path and compare it to the actual path the object took between those two observations—the greater the difference—the more “jaggedness”. The two observations shall have at least one observation, or point, between themselves, i.e. the two observations shall not be directly adjacent.

Similarly as above, the path may be discarded or kept based on whether or not the jaggedness of the paths fulfills or fails to fulfill a jaggedness threshold.

In this example, the criterion relates to speed of the tracked object. As an example, the speed of the object may be estimated based on at least two observations, such as recent observations, the last two observations, or the like. The speed may then be estimated by dividing the distance travelled by the object with the time between a first observation and a last observation, in time, among said at least two observations. As an example, the speed may be estimated by determining the modulus, or the magnitude, of the vector for direction/angle as explained above.

Similarly as above, the path may be discarded or kept based on whether or not the speed for the object in the paths fulfills or fails to fulfill a speed threshold.

c)

The region tracking condition can comprise a third instruction that the observation shall be discarded, and that the observation shall be replaced with an extrapolated observation. For each path that may be expected to have an actual observation within the region, an extrapolated observation may be added to the path. Expressed differently, paths may be extended by extrapolation regardless of whether or not there was an observation within the region. This means that when a path heads into the region, extrapolated observation(s) can be appended to the path while actual blobs in the region are ignored. Hence, any actual observations within the region are discarded. Paths that cross the region are allowed to use extrapolated observations. These observations can be added to the path at a significantly lower penalty (if any) compared to a penalty the path would get by adding an extrapolated point outside the region.

In this manner, inclusion of observations, i.e. actual observations as opposed to extrapolated observations, into the path in the region is not allowed. This may be reasonable due to geometric constraints or the fact that the FoV of the sensor is obscured. Nevertheless, as the tracked object may become visible again, it may be beneficial to continue tracking in the region, but instead generate extrapolated observations to be included in the path for further tracking.

An alternative to use extrapolated observations is to change the software gain or variance cutoff limits for observations in a particular region. This translates to using a different threshold for which sensor readings should be accepted as an observation of the trajectory or to applying a different noise threshold, deciding whether a detected deviation from the background model is significant enough to assume that it may be a potential observation, such as a blob.

d)

The region tracking condition can comprise a fourth instruction that the observation shall be included in order to continue the tracking of the object. This means that use of an extrapolated observation derived from the path is not allowed.

In some cases, a region of the FoV of the sensor can contain a lot of noise, but also have a high SNR for the object to be tracked. This warrants a region tracking condition where observations from the sensor are required in order to continue the path. Otherwise, when not in this region the path may be allowed to use extrapolated observations as discussed above.

e)

The region tracking condition can comprise a fifth instruction that the observation, comprising a blob, shall be discarded when a blob brightness, i.e. a brightness of the blob, is less than a background at the blob. E.g. an average brightness of brightness of pixels at the position of the blob, e.g. for a number of preceding image frames. In this manner, it may be avoided that shadows are interpreted as being moving sports projectiles. The number of preceding image frames may be dynamic or predetermined. When a predetermined number is used, e.g. the brightness of the background at a given position may be an average of the brightness for the last thirty-two image frames, or other suitable number, at the position(s) given by the blob.

In some examples, the brightness of the blob is an aggregated value, such as an average of the brightness of the pixels in the blob. In some examples, the brightness of the blob includes a collection of brightness values, i.e. one brightness value for each pixel in the blob.

When determining whether the blob brightness is less than the background brightness, it may be that each value of the collection of brightness values is compared to the background brightness.

Expressed differently, the fifth instruction implies that the observation shall have a brightness higher than the background, i.e. not track shadows of objects. If the sensor is a camera, the observation might be a deviation of a pixel, compared to its background. This deviation can either be brighter or darker than the background. Depending on the environment, such as the absolute brightness of the background, and the location of light sources (including the sun), compared to the tracked object, despite the object itself having a certain color, it can usually be either darker or lighter than the background. There are however situations where it's reasonable to assume that a golf ball moving in the image will result in a positive deviation in the pixel, i.e. it is brighter when the golf ball passes over the pixel. This could for example be the case if there is a lot of light in the environment, and the background includes, or depicts, ground known to be darker than the golf ball. In such situations, it makes sense to apply a policy that requires an observation to be a positive deviation, compared to the background, i.e. the pixel of the observation becomes brighter.

f)

The region tracking condition can comprise a sixth instruction that the observation, comprising a blob, shall be discarded when the blob satisfies a threshold for allowed minimum or maximum size for blobs in the path. When the threshold refers to an allowed minimum size, the threshold is satisfied when a size of the blob is greater than, or equal to, the threshold. When the threshold refers to an allowed maximum size, the threshold is satisfied when a size of the blob is less than, or equal to, the threshold. The allowed minimum or maximum size may apply to one or two dimensions, such as X or Y dimension of the blob or both. In examples with two dimensions, there may be a respective maximum or minimum threshold for each dimension, i.e. one for the X dimension and one for the Y dimension of the blob. X dimension generally refers to width of the blob and Y dimension generally refers to height of the blob. Then, the respective maximum or minimum threshold for one dimension may or may not be different from the maximum or minimum threshold for the other dimension. In most cases, two dimensions are considered. As a further example, an allowed minimum or maximum size may be given as an area in square pixel units. As a yet other example, an allowed minimum or maximum size may be measured in only one dimension along, or perpendicularly to, a direction of movement for the path.

In this manner only those blobs of the observations that satisfy the region tracking condition of the sixth instruction will be included in the path for further tracking. This may be beneficial in case the region of this region tracking condition has a lot of noise, which generates many blobs that may be smaller than the expected sports projectile's size. Then all these smaller blobs may be disregarded from the tracking.

Notably, when applying this region tracking condition, it may be applied as a part of the obtaining of the observation. This would then result in a reduction of the detected observations, e.g. the observations reported by the blob detection procedure, or the observations available for evaluation, etc.

In some embodiments, e.g. for region tracking condition(s) including a) the first instruction and/or c) the third instruction, the evaluation action A140 comprises evaluating whether the path fulfills the region tracking condition or not. The retaining A150 comprises retaining the path when the path fails to fulfill the region tracking condition. Furthermore, the discarding A160 comprises discarding the path when the path fulfills the region tracking condition. In this manner, the path(s) that fulfills the region tracking condition(s) are filtered out.

In some embodiments, e.g. when the region tracking condition comprises a) the first instruction and/or c) the third instruction, the evaluation action A140 comprises evaluating whether the path fulfills the region tracking condition or not. The retaining A150 comprises retaining the path when the path fulfills the region tracking condition. Furthermore, the discarding A160 comprises discarding the path when the path fails to fulfill the region tracking condition. In this manner, the path(s) that fulfills the region tracking condition(s) are filtered in.

In some embodiments, e.g. when the region tracking condition comprises b) the second instruction, the evaluation action A140 comprises evaluating whether the observation, comprising the blob, fulfills the region tracking condition or not. The retaining A150 comprises including the observation in the path when the region tracking condition is fulfilled. Furthermore, the discarding A160 comprises discarding the observation when the region tracking condition is rejected, e.g. not fulfilled. In this manner, the path(s) that fulfills the region tracking condition(s) are filtered in.

In some embodiments, e.g. when the region tracking condition comprises b) the second instruction, the evaluation action A140 comprises evaluating whether the observation, comprising the blob, fulfills the region tracking condition or not. The retaining A150 comprises including the observation in the path when the region tracking condition is fulfilled. Furthermore, the discarding A160 comprises discarding the observation when the region tracking condition is rejected, e.g. not fulfilled. In this manner, the path(s) that fulfills the region tracking condition(s) are filtered in.

In some embodiments, e.g. when the region tracking condition comprises b) the second instruction, the evaluation action A140 comprises evaluating whether the observation, comprising the blob, fulfills the region tracking condition or not. The retaining A150 comprises including the observation in the path when the region tracking condition is rejected, i.e. not fulfilled. Furthermore, the discarding A160 comprises discarding the observation when the region tracking condition is fulfilled. In this manner, the path(s) that fulfills the region tracking condition(s) are filtered out.

In some embodiments, e.g. when the region tracking condition comprises d) the fourth instruction, the evaluation action A140 comprises determining that the observation fulfills the region tracking condition. Furthermore, the discarding A160 comprises discarding the observation and including the extrapolated observation in the path, when the region tracking condition is fulfilled.

In some embodiments, e.g. when the region tracking condition comprises e) the fifth instruction, the evaluation action A140 comprises determining that the observation fulfills the region tracking condition. Furthermore, the retaining A150 comprises including the observation in the path.

In some embodiments, the object 130 is a sports projectile, such as a ball, a golf ball, a tennis ball, a boule ball, a football, a soccer ball, a badminton ball, a curling stone or the like.

In some embodiments, the three-dimensional environment 100 is a golfing area, such as a golf course, a driving range, or the like.

In some embodiments, the object 130 is at least partly in flight though air in the three-dimensional environment 100 when moving.

In some embodiments, the obtaining A120 of the observation is comprised in an action of obtaining a sequence of observations, including said observation. Furthermore, actions A130-A140 and one of actions A150 and A160 are performed for each observation of the sequence of observations. In a real-life example, the vast majority of the observations may be false positives, and the method herein assists with finding the observations that most likely belong to an actual object(s) to be tracked.

In some examples, as illustrated in FIG. 4, a method for managing the tracking of an object is provided. At least some of the features and/or actions in this method may be combined with the example(s) above.

One or more of the following actions may be performed.

### Action A110

This action is similar to action A110 of FIG. 3. In this example, a memory 117 is used for storing of the region(s) and the associated region tracking condition(s). The same features as mentioned for the memory described in connection with action A110 of FIG. 3 applies to the memory 117 of FIG. 4.

Action A120 is the same, or similar to, action A120 of FIG. 3.

### Action A125

This exemplifying action illustrates that the computing apparatus 110 may loop over each region and/or each region tracking condition. The computing apparatus 110 may thus retrieve the region and the associated region tracking condition that the observation obtained in action A120 may be checked against.

### Action A130

This action is a checking action to check if it can be determined that the observation matches the region or that it can be determined that the observation does not match the region, e.g. the observation is outside the region.

Action A140 is the same, or similar to, action A140 of FIG. 3.
Action A150 is the same, or similar to, action A150 of FIG. 3.
Action A160 is the same, or similar to, action A160 of FIG. 3.

Subsequent to action A150 or A160, any further existing region(s) and/or region tracking condition(s) will be checked and when applicable evaluated in action A130 and action A140, respectively.

### Action A165

When the outcome of action A130 it that it is determined that the observation does not match the region, the procedure will continue to action A125 if there are any non-checked and/or non-evaluated regions and region tracking conditions left, e.g. for the observation being checked and/or evaluated. In case all regions and/or region tracking conditions have been checked and/or evaluated against the present observation, the procedure may continue with a next observation. The next observation may be available directly or may be waited upon, e.g. waited upon from the perspective of the computing apparatus which may, or may not, have some idle time between observation.

With reference to FIG. 5, a schematic block diagram of embodiments of the computing apparatus 110 of FIG. 1 is shown. The computing apparatus 110 may be configured to perform one or more of the embodiments and/or examples of the method herein.

The computing apparatus 110 may comprise a processing unit 501, which e.g. can perform the methods described herein. The processing unit 501 may be embodied in the form of one or more hardware units and/or one or more software units. The term “unit” may thus refer to a circuit, i.e. hardware, a software block or the like according to various embodiments as described below.

The computing apparatus 110 may further comprise a memory 502. The memory may comprise, such as contain or store, instructions, e.g. in the form of a computer program 503, which may comprise computer readable code units.

According to some embodiments herein, the computing apparatus 110 and/or the processing unit 501 comprises a processing circuit 504 as an exemplifying hardware unit, which may comprise one or more processors. Accordingly, the processing unit 501 may be embodied in the form of, or ‘realized by’, the processing circuit 504. The instructions may be executable by the processing circuit 504, whereby the computing apparatus 110 is operative to perform the methods of FIG. 2 and/or FIG. 3. As another example, the instructions, when executed by the computing apparatus 110 and/or the processing circuit 504, may cause the computing apparatus 110 to perform the method according to FIG. 2 and/or FIG. 3.

In view of the above, in one example, there is provided a computing apparatus 110 for managing tracking of an object 130 moving in a three-dimensional environment 100. Again, the memory 502 contains the instructions executable by said processing circuit 504 whereby the computing apparatus 110 is operative for:
obtaining A110 an indication of a region 105, 106, 107 and a region tracking condition to be applied to the tracking of the object 130 in the region 105, 106, 107, wherein the region 105, 106, 107 pertains to a portion of a field of view 125 of an electromagnetic sensor 120 for tracking of the object 130 in the three-dimensional environment 100,
obtaining A120 an observation relating to the tracking of the object 130, wherein the observation is generated based on at least one two-dimensional representation of the field of view (125), wherein said at least one two-dimensional representation has been captured by the electromagnetic sensor 120, and wherein the observation is includable in a set of observations defining a path of the object 130 in the field of view 125,
determining A130 that the observation matches the region 105, 106, 107,
in an evaluation action A140, evaluating A140 whether the observation and/or the path fulfills the region tracking condition of the region 105, 106, 107 or not, and wherein the computing apparatus 110 further is operative for:
retaining A150, based on the evaluation action A140, the observation and/or the path in continued tracking of the object 130, or
discarding A160, based on the evaluation action A140, the observation and/or the path from continued tracking of the object 130,
wherein the region tracking condition comprises one or more of:
   a) a first instruction that the path shall be discarded when the path includes one observation,
   b) a second instruction that the path shall be discarded when the path, including the observation, fulfils a criterion relating to one or more of an angle, a speed, and a jaggedness,
   c) a third instruction that the observation shall be discarded, and that the observation shall be replaced with an extrapolated observation derived from the path, in which the observation is not included,
   d) a fourth instruction that the observation shall be included in order to continue the tracking of the object, while not allowing use of an extrapolated observation derived from the path, in which the observation is not included,
   e) a fifth instruction that the observation, comprising a blob, shall be discarded when a brightness of the blob is less than a brightness of a background at the blob, and
   f) a sixth instruction that the observation, comprising a blob, shall be discarded when the blob satisfies a threshold for allowed minimum/maximum size for blobs in the path.

FIG. 5 further illustrates a carrier 505, or program carrier, which provides, such as comprises, mediates, supplies and the like, the computer program 503 as described directly above. The carrier 505 may be one of an electronic signal, an optical signal, a radio signal and a computer readable medium.

In some embodiments, the computing apparatus 110 and/or the processing unit 501 may comprise one or more of an obtaining unit 510, a determining unit 520, an evaluating unit 530, a retaining unit 540, and a discarding unit 550 as exemplifying hardware units. The term “unit” may refer to a circuit when the term “unit” refers to a hardware unit. In other examples, one or more of the aforementioned exemplifying hardware units may be implemented as one or more software units.

Moreover, the computing apparatus 110 and/or the processing unit 501 may comprise an Input/Output (I/O) unit 506, which may be exemplified by a receiving unit and/or a sending unit when applicable.

Accordingly, the computing apparatus 110 is configured for managing tracking of an object 130 moving in a three-dimensional environment 100.

Therefore, according to the various embodiments described above, the computing apparatus 110 and/or the processing unit 401 and/or the obtaining unit 510 is configured for obtaining an indication of a region 105, 106, 107 and a region tracking condition to be applied to the tracking of the object 130 in the region 105, 106, 107. The region 105, 106, 107 pertains to a portion of a field of view 125 of an electromagnetic sensor 120 for tracking of the object 130 in the three-dimensional environment 100.

The computing apparatus 110 and/or the processing unit 401 and/or the obtaining unit 510, or a further obtaining unit (not shown), is configured for obtaining an observation relating to the tracking of the object 130. The observation is generated based on at least one two-dimensional representation of the field of view (125), wherein said at least one two-dimensional representation has been captured by the electromagnetic sensor 120, and wherein the observation is includable in a set of observations defining a path of the object 130 in the field of view 125.

The computing apparatus 110 and/or the processing unit 401 and/or the determining unit 520 is configured for determining that the observation matches the region 105, 106, 107.

In an evaluation action A140, the computing apparatus 110 and/or the processing unit 401 and/or the evaluating unit 530 is configured for evaluating whether the observation and/or the path fulfills the region tracking condition of the region 105, 106, 107 or not.

The computing apparatus 110 and/or the processing unit 401 and/or the retaining unit 540 is configured for retaining, based on the evaluation action A140, the observation and/or the path in continued tracking of the object 130.

The computing apparatus 110 and/or the processing unit 401 and/or the discarding unit 550 is configured for discarding, based on the evaluation action A140, the observation and/or the path from continued tracking of the object 130. The region tracking condition comprises one or more of:
a) a first instruction that the path shall be discarded when the path includes one observation,
b) a second instruction that the path shall be discarded when the path, including the observation, fulfils a criterion relating to one or more of an angle, a speed, and a jaggedness,
c) a third instruction that the observation shall be discarded, and that the observation shall be replaced with an extrapolated observation derived from the path, in which the observation is not included,
d) a fourth instruction that the observation shall be included in order to continue the tracking of the object, while not allowing use of an extrapolated observation derived from the path, in which the observation is not included,
e) a fifth instruction that the observation, comprising a blob, shall be discarded when a brightness of the blob is less than a brightness of a background of at the blob, and
f) a sixth instruction that the observation, comprising a blob, shall be discarded when the blob satisfies a threshold for allowed minimum/maximum size for blobs in the path.

As used herein, a set of items refers to one or more items.

As used herein, the term “image” refers to an array or matrix of pixels in two or three dimensions, where a value of each pixel represents an amount of electromagnetic radiation that the pixel has been exposed to.

As used herein, tracking of an object refers to executing a tracking procedure for tracking of the object. It may be noted that a tracking procedure may comprise one or more sub-procedures, such as one or more of an image retrieval procedure, a blob detection procedure, a path detection procedure, and the like.

As used herein, the term “unit” may refer to one or more functional units, each of which may be implemented as one or more hardware units and/or one or more software units and/or a combined software/hardware unit in a node. In some examples, the unit may represent a functional unit realized as software and/or hardware of the node.

As used herein, the term “computer program carrier”, “program carrier”, or “carrier”, may refer to one of an electronic signal, an optical signal, a radio signal, and a computer readable medium. In some examples, the computer program carrier may exclude transitory, propagating signals, such as the electronic, optical and/or radio signal. Thus, in these examples, the computer program carrier may be a non-transitory carrier, such as a non-transitory computer readable medium.

As used herein, the term “processing unit” may include one or more hardware units, one or more software units or a combination thereof. Any such unit, be it a hardware, software or a combined hardware-software unit, may be a determining means, estimating means, capturing means, associating means, comparing means, identification means, selecting means, receiving means, sending means or the like as disclosed herein. As an example, the expression “means” may be a unit corresponding to the units listed above in conjunction with the Figures.

As used herein, the term “software unit” may refer to a software application, a Dynamic Link Library (DLL), a software component, a software module, a software object, a React component, an object according to Component Object Model (COM), a software function, a software engine, an executable binary software file or the like.

The terms “processing unit” or “processing circuit” may herein encompass e.g. one or more processors, an Application Specific Integrated Circuit (ASIC), a Field-Programmable Gate Array (FPGA) or the like. The processing circuit or the like may comprise one or more processor kernels.

As used herein, the expression “configured to/for” may mean that a processing circuit is configured to, such as adapted to or operative to, by means of software configuration and/or hardware configuration, perform one or more of the actions described herein.

As used herein, the term “action” may refer to an action, a step, an operation, a response, a reaction, an activity or the like. It shall be noted that an action herein may be split into two or more sub-actions as applicable. Moreover, also as applicable, it shall be noted that two or more of the actions described herein may be merged into a single action.

As used herein, the term “memory” may refer to a hard disk, a magnetic storage medium, a portable computer diskette or disc, flash memory, random access memory (RAM) or the like. Furthermore, the term “memory” may refer to an internal register memory of a processor or the like.

As used herein, the term “computer readable medium” may be a Universal Serial Bus (USB) memory, a Digital Versatile Disc (DVD), a Blu-ray disc, a software unit that is received as a stream of data, a Flash memory, a hard drive, a memory card, such as a MemoryStick, a Multimedia Card (MMC), Secure Digital (SD) card, etc. One or more of the aforementioned examples of computer readable medium may be provided as one or more computer program products.

As used herein, the term “computer readable code units” may be text of a computer program, parts of or an entire binary file representing a computer program in a compiled format or anything there between.

Any feature disclosed for one example and/or embodiment may be combined with one or more features disclosed for one or more other examples and/or embodiments without departing from the scope herein.

1. A method, performed by a computing apparatus, for managing tracking of an object moving in a three-dimensional environment, wherein the method comprises:
obtaining an indication of a region and a region tracking condition to be applied to the tracking of the object in the region, wherein the region pertains to a portion of a field of view of an electromagnetic sensor for tracking of the object in the three-dimensional environment,
obtaining an observation relating to the tracking of the object, wherein the observation is generated based on at least one two-dimensional representation of the field of view, wherein said at least one two-dimensional representation has been captured by the electromagnetic sensor, and wherein the observation is includable in a set of observations defining a path of the object in the field of view,
determining that the observation matches the region,
in an evaluation action, evaluating whether the observation and/or the path fulfills the region tracking condition of the region or not, and
wherein the method comprises:
retaining, based on the evaluation action, the observation and/or the path in continued tracking of the object, or
discarding, based on the evaluation action, the observation and/or the path from continued tracking of the object,
wherein the region tracking condition comprises one or more of:
a second instruction that the path shall be discarded when the path, including the observation, fulfils a criterion relating to a speed and/or a jaggedness,
a third instruction that the observation shall be discarded, and that the observation shall be replaced with an extrapolated observation derived from the path, in which the observation is not included,
a fourth instruction that the observation shall be included in order to continue the tracking of the object, while not allowing use of an extrapolated observation derived from the path, in which the observation is not included, and/or
a fifth instruction that the observation, comprising a blob, shall be discarded when a brightness of the blob is less than a brightness of a background at the blob.

2. The method according to claim 1, wherein the region tracking condition comprises a first instruction that the path shall be discarded when the path includes only one observation and the third instruction, and the path comprises an existing path and a new path, wherein
the evaluation action comprises evaluating whether the new path fulfills the region tracking condition or not, and
the retaining comprises retaining the existing path using the extrapolated observation derived from the existing path, and the discarding comprises discarding the observation and the new path including the observation as the only observation, when the region tracking condition is fulfilled.

3. The method according to claim 1, wherein the region tracking condition comprises the second instruction, wherein
the evaluation action comprises evaluating whether the observation and the path fulfill the region tracking condition or not,
the retaining comprises including the observation in the path when the region tracking condition is fulfilled, and
the discarding comprises discarding the observation when the region tracking condition is rejected.

4. The method according to claim 1, wherein the region tracking condition comprises the second instruction, wherein
the evaluation action comprises evaluating whether the observation and the path fulfill the region tracking condition or not,
the retaining comprises including the observation in the path when the region tracking condition is rejected, and
the discarding comprises discarding the observation when the region tracking condition is fulfilled.

5. The method according to claim 1, wherein the region tracking condition comprises the fifth instruction, wherein
the evaluation action comprises determining that the observation fulfills the region tracking condition, and
the retaining comprises including the observation in the path.

6. The method according to claim 1, wherein the region tracking condition comprises a first instruction that the path shall be discarded when the path includes only one observation and the second instruction.

7. The method according to claim 6, wherein the region tracking condition comprises the third instruction.

8. The method according to claim 6, wherein the region tracking condition comprises the fourth instruction.

9. The method according to claim 8, wherein the region tracking condition comprises the fifth instruction.

10. The method according to claim 1, wherein the obtaining comprises obtaining a further indication of a further region and a further region tracking condition to be applied to the tracking of the object in the further region, wherein the further region pertains to a portion of the field of view.

11. The method according to claim 10, wherein the obtaining comprises receiving the further indication and the further region tracking condition as user input.

12. The method according to claim 10, wherein the region partially overlaps with the further region and both of the region and the further region cover less than all of the field of view.

13. The method according to claim 10, wherein the further region tracking condition comprises the third instruction applied to the tracking of the object in the further region.

14. The method according to claim 1, wherein the obtaining of the observation is comprised in an action of obtaining a sequence of observations, including said observation, wherein the determining and the evaluation action and one of the retaining and the discarding are performed for each observation of the sequence of observations.

15. A computing apparatus comprising:
one or more computer processors; and
one or more computer memories configured to cause the one or more computer processors to manage tracking of an object moving in a three-dimensional environment, by performing operations comprising:
obtaining an indication of a region and a region tracking condition to be applied to the tracking of the object in the region, wherein the region pertains to a portion of a field of view of an electromagnetic sensor for tracking of the object in the three-dimensional environment,
obtaining an observation relating to the tracking of the object, wherein the observation is generated based on at least one two-dimensional representation of the field of view, wherein said at least one two-dimensional representation has been captured by the electromagnetic sensor, and wherein the observation is includable in a set of observations defining a path of the object in the field of view,
determining that the observation matches the region,
in an evaluation action, evaluating whether the observation and/or the path fulfills the region tracking condition of the region or not, and
wherein the operations comprise:
retaining, based on the evaluation action, the observation and/or the path in continued tracking of the object, or
discarding, based on the evaluation action, the observation and/or the path from continued tracking of the object,
wherein the region tracking condition comprises one or more of:
a second instruction that the path shall be discarded when the path, including the observation, fulfils a criterion relating to a speed and/or a jaggedness,
a third instruction that the observation shall be discarded, and that the observation shall be replaced with an extrapolated observation derived from the path, in which the observation is not included,
a fourth instruction that the observation shall be included in order to continue the tracking of the object, while not allowing use of an extrapolated observation derived from the path, in which the observation is not included, and/or
a fifth instruction that the observation, comprising a blob, shall be discarded when a brightness of the blob is less than a brightness of a background at the blob.

16. The computing apparatus according to claim 15, wherein the obtaining comprises obtaining a further indication of a further region and a further region tracking condition to be applied to the tracking of the object in the further region, wherein the further region pertains to a portion of the field of view.

17. The computing apparatus according to claim 16, wherein the region partially overlaps with the further region and both of the region and the further region cover less than all of the field of view.

18. A non-transitory computer readable medium encoding a computer program configured to cause one or more computing apparatus to perform operations comprising:
obtaining an indication of a region and a region tracking condition to be applied to the tracking of the object in the region, wherein the region pertains to a portion of a field of view of an electromagnetic sensor for tracking of the object in the three-dimensional environment,
obtaining an observation relating to the tracking of the object, wherein the observation is generated based on at least one two-dimensional representation of the field of view, wherein said at least one two-dimensional representation has been captured by the electromagnetic sensor, and wherein the observation is includable in a set of observations defining a path of the object in the field of view,
determining that the observation matches the region,
in an evaluation action, evaluating whether the observation and/or the path fulfills the region tracking condition of the region or not, and
wherein the operations comprise:
retaining, based on the evaluation action, the observation and/or the path in continued tracking of the object, or
discarding, based on the evaluation action, the observation and/or the path from continued tracking of the object,
wherein the region tracking condition comprises one or more of:
a second instruction that the path shall be discarded when the path, including the observation, fulfils a criterion relating to a speed and/or a jaggedness,
a third instruction that the observation shall be discarded, and that the observation shall be replaced with an extrapolated observation derived from the path, in which the observation is not included,
a fourth instruction that the observation shall be included in order to continue the tracking of the object, while not allowing use of an extrapolated observation derived from the path, in which the observation is not included, and/or
a fifth instruction that the observation, comprising a blob, shall be discarded when a brightness of the blob is less than a brightness of a background at the blob.

19. The non-transitory computer readable medium according to claim 18, wherein the obtaining comprises obtaining a further indication of a further region and a further region tracking condition to be applied to the tracking of the object in the further region, wherein the further region pertains to a portion of the field of view.

20. The non-transitory computer readable medium according to claim 19, wherein the region partially overlaps with the further region and both of the region and the further region cover less than all of the field of view.
